(19) United States
(12) Patent Application Publication
(10) Pub. No.: US 2004/0116563 A1
(43) Pub. Date: Jun. 17, 2004

(54) Method for separating at least one selected polymer from a mixture of polymers

(76) Inventors: Erwin Feick, Florsheim (DE); Brigitte Heller, Florsheim (DE); Thomas Kaiser, Kelkheim (DE); Steffen Ruf, Sackingen (DE); Robert Schleich, Kelkheim (DE); Bernd Bungert, Hofheim (DE); Andreas Thiele, Aachen (DE); Guido Gorski, Kurten (DE)

Correspondence Address: SHAW PITTMAN, IP GROUP, 1650 TYSONS BOULEVARD, SUITE 1300, MCLEAN, VA, 22102, US

(21) Appl. No.: 10/450,419

(22) PCT Filed: Dec. 14, 2001
(86) PCT No.: PCT/DE01/04705

(30) Foreign Application Priority Data
Dec. 15, 2000 (DE) 10062432.4

(51) Int. Cl. C08K 5/17

(52) U.S. Cl. 524/236; 524/379; 524/356; 524/284; 524/502

(57) ABSTRACT

The present invention provides a method for separating one or more selected polymer(s) from a mixture of polymers, as well as the recycled solid polymer product produced by the present method of the invention. One method of the present invention involves dissolving a mixture of polymers in a solvent to produce a solution, then cooling the solution to a temperature at which at least one of the selected polymers precipitates in the form of a solid. The solid is then separated from the suspension before being washed in a solvent at a temperature that is higher than the dissolving temperature, in order to produce a washed solid. The washed solid is separated from the second solvent. In one variant of the method, the suspension produced in the cooling step is treated with an added solvent.

This application claims priority to German Application No. 10062432.4, filed Dec. 15, 2000, and PCT/DE01/04705 filed Dec. 12, 2001, each of which are incorporated by reference herein in their entirety.

### BACKGROUND

1. Priority

2. Field of the Invention

The invention relates to a method for separating at least one polymer from a mixture of polymers.

3. Background of the Invention

When recycling mixtures of plastics, the option is to selectively dissolve one or more polymers contained in the mixture of plastics using extraction with a solvent. One example of such mixtures of plastics are those in a fraction collected through the yellow bag or the yellow bin program run by the Duales System. For example, EP 0 491 836 B1proposes using suitable solvents in this manner to separate Low Density Polyethylene (LDPE), High Density Polyethylene (HDPE) Polypropylene (PP), Polystyrol (PS) and Polyvinylchloride (PVC) polymers. However, this method is unsuitable for use with composite materials. Furthermore, even if the plastics were uncontaminated and cleaned, the diffusion steps necessary for proper implementation of the method will considerably impede kinetically the extraction of polymer at concentrations over 10 to 40 wt. %. This means long extraction times and poor utilization of space and time, which in turn can lead to high investment costs that will prevent large-scale use.

DE 198 22 234 A1 describes a method for separating plastics by the dissolution of a mixture of plastics in a solvent whereby insoluble components are extracted using solid-liquid separation. By lowering the temperature, the dissolved plastics are selectively precipitated.

Methods by which precipitation occurs by adding a precipitant are described in the technical literature.

Prior art has thus far not disclosed a method by which complete separation is achieved using these methods. Furthermore, there remains the problem of separating the precipitated solid polymers from the solution containing the remaining polymers (the so-called mother lye) using solid-liquid separation methods. The separated solid always contains some residual moisture; and, thus is contaminated with the dissolved polymers contained in the moisture. The removal of the mother lye containing polymers occurs by rewashing it using, for example, cleaned solvent. However, the problem of the incomplete separation that occurs in the precipitation step is not corrected or improved in this manner.

The technical literature discloses producing a solution consisting of LDPE, HDPE and PP for precipitation tests by lowering the temperature. Using the solid-liquid separation methods and subsequent repeated washing at the precipitation temperature, an LDPE rich mother lye is produced. The solid contained therein contained significant amounts of LDPE, and was rich in HDPE and PP.

### SUMMARY OF THE INVENTION

The present invention is directed to a method for separating one or more selected polymer(s) from a mixture of polymers, as well as the recycled solid polymer product produced by the present method of the invention. One embodiment of the method of the present invention involves dissolving a mixture of polymers in a solvent to produce a solution, then cooling the solution to a temperature at which at least one of the selected polymers precipitates in the form of a solid. The solid is then separated from the suspension before being washed in a solvent at a temperature that is higher than the dissolving temperature, in order to produce a washed solid. The washed solid is separated from the second solvent.

In another embodiment of the present invention, a mixture of polymers is similarly dissolved in a solvent to produce a solution. The solution is cooled to a temperature at which at least one selected polymer precipitates in the form of a solid before it is heated to a temperature that is higher than the temperature at which the selected polymer precipitates. The solid is then separated from the heated suspension.

### DETAILED DESCRIPTION OF THE INVENTION

It is thus an objective of the present invention to provide a method that will quantitatively separate at least one selected polymer from a mixture of polymers whereby the fractions obtained are only contaminated to a limited extent with components from other fractions. It is a further object of the present invention to provide a method that produces a relatively clean precipitated polymer.

This objective is achieved with methods of the present invention, which are described in the instant specification, the embodiments and claims.

In one embodiment of the present invention provides a product comprised of a solid produced by the methods. Specifically, one embodiment of the present inventor provides a product produced by a method of the present invention in which the mixture of polymers comprises polyethylene and polypropylene. Another embodiment provides a product produced by a method of the present invention in which the mixture of polymers comprises less than 30 wt. % LDPE or LLDPE, preferably less than 20 wt. % LDPE or LLDPE.

One embodiment of the present invention provides a method for separating at least one selected polymer from a mixture of polymers, comprising of the following steps: a) dissolution of the mixture of polymers in a first solvent to produce a solution, whereby the concentration of the mixture of polymers in the solution is adjusted to between 1 wt. % and 50 wt. %; b) cooling the solution to a temperature T1 at which said at least one selected polymer precipitates at least partially in the form of a solid, to produce a suspension containing a solid; c) separating said solid from the suspension; d) washing the separated solid in a second solvent at a temperature T2, wherein temperature T2 is higher than temperature T1, to produce a washed solid; and e) separating the washed solid from the second solvent.

Solid-liquid separation methods are used to separate the solid from the solution or separate the washed solid from the solution.

In another embodiment of the method of the present invention, at least one selected polymer is separated from a mixture of polymers, by a method comprising the following steps: a) dissolution of the mixture of polymers in a first solvent to produce a solution, whereby the concentration of the mixture of polymers in the solution is adjusted to between 1 wt. % and 50 wt. %; b) cooling the solution to a temperature T3 at which said at least one selected polymer precipitates at least partially in the form of a solid, to produce a suspension containing a solid; c) heating the suspension to a temperature T4, wherein temperature T4 is higher than temperature T3, to produce a heated suspension and a solid; and d) separating the solid in said heated suspension from said heated suspension.

Additional embodiments of the method of the present invention are particularly suitable for polyolefins and, among those, the types used for plastics, such as Low Density Polyethylene (LDPE), Linear Low Density Polyethylene (LLDPE), Medium Density Polyethylene (MDPE), (High Density Polyethylene), (HDPE), Ultra High Density Polyethylene (UHDPE) and/or Polypropylene (PP).

In a preferred method of the present invention, the concentration of the mixture of polymers in the first solvent is from about 2 wt. % to about 40 wt. %, and more preferably from about 5 wt. % to about 20 wt. %.

The choice of temperatures T1 and T2 or, as the case may be, T3 and T4 varies according to the polymers and solutions used. To effectively implement the present invention, preferably, temperature T2 is set at between 5° C. to 40° C. above the precipitation temperature T1 and, more preferably, between 10° C. to 30° C. above the precipitation temperature T1. Correspondingly, the temperature T4 should be set at 5° C. to 40° C. above the precipitation temperature T3 and more preferably, between 10° C. to 30° C. above the precipitation temperature T3.

For the implementation of the alternative methods in accordance with claim 1, the first solvent and the second solvent could be chemically identical, whereby however, the second solvent always should be a “fresh” solvent so it is not contaminated by polymers.

Another option also to be provided for allows the second solvent to be returned to dissolve the initial mixture of polymers.

The solvent used could be aliphatic, aromatic or cyclical, saturated or unsaturated hydrocarbons, alcohols, carboxylic acids, amines, esters, ketones, tetrahydrofurane, dimethylformamide, dimethylsulphoxide, N-Methylpyrrolidone or mixtures thereof.

Another option could be that the precipitation of the solid is supported by the addition of a precipitant.

The mixtures of the above mentioned polyethylenes and polypropylenes which have been treated with the method according to the present invention, contain more than 85 wt. % LDPE and LLDPE in the mother lye while, on the other hand, the rewashed solid contains less than about 30 wt. % LDPE or LLDPE, preferably less than about 20wt. % LDPE or LLDPE. The purity and/or content of LDPE or LLDPE in the mother lye can be ascertained using common methods to analyze the data from differential scanning calorimetry (DSC) to obtain a DSC-curve. The lowered LDPE or LLDPE content in the sample can be proven by the absence of a shoulder in the DSC-curve obtained by DSC conducted at the melting point range of LDPE or LLDPE.

The invention is described below in greater detail in the implementation examples. The Examples merely represent possible embodiments of the present invention. The Examples are not intended to limit the present invention to any of the embodiments described in the Examples.

### EXAMPLE 1

A mixture of 10 g LDPE, 10 g HDPE and 10 g PP is dissolved in 570 g n-decane at 155° C. to produce a solution. A suspension containing precipitated particles is obtained by cooling this mixture to 76° C. The suspension is separated into a solid and a mother lye by filtering in a funnel. The solid is agitated at 94° C. for 30 minutes with 890 g n-decane before filtering again. The mother lye as well as the wash filtrate is concentrated by evaporation and the fibers are dried. The plastic contained in the particles has, apart from PP and HDPE, no LDPE content. The plastic content of the particles can be proven by the lack of a shoulder in a DSC curve obtained when DSC is conducted at the melting point of clean LDPE.

### EXAMPLE 2

A mixture consisting of 40 g LDPE, 40 g HDPE and 20 g PP is dissolved in 825g n-octane at 155° C to produce a solution. By cooling the solution to 76° C., a suspension containing precipitated particles is obtained. This suspension is filtered to remove the particles. The suspension is diluted with 435 g n-octane, and agitated at 92° C. for 34 minutes before filtering again to produce the mother lye and the wash filtrate. The mother lye as well as the wash filtrate is concentrated by evaporation and the fibers are dried. The plastic contained in the mother lye consists of more than 80 wt. % LDPE. The plastic contained in the particles has, apart from PP and HDPE, no LDPE content. The plastic content of the particles can be proven by the lack of a shoulder in DSC curve obtained when DSC is conducted at the melting point of clean LDPE.

### EXAMPLE 3

By comparison, particles having a significant LDPE content are produced in the following method, in which the cooled suspension is not heated to a temperature that is greater than the cooled temperature. A mixture consisting of 10 g LDPE, 10 g HDPE and 10 g PP is dissolved in 570 g n-decane at 155° C. to produce a solution. A suspension is obtained by cooling the solution to 76° C. This suspension is separated into a solid and a mother lye by filtering in a funnel. The solid is agitated at 76° C. for 30 minutes with 890 g n-decane before filtering again. The mother lye as well as the wash filtrate is concentrated by evaporation and the fibers are dried. The plastic contained in the mother lye consists of more than 80 wt. % LDPE. The plastic contained in the particles has a significant LDPE content, apart from PP and HDPE. The plastic content of the particles can be proven by the lack of a shoulder in DSC curve obtained when DSC is conducted at the melting point of clean LDPE.

The characteristics of the invention disclosed in the above description as well as in the patent claims are significant for the implementation of the invention individually as well as in any combination. The foregoing disclosure of the embodiments of the invention has been presented for purposes of illustration and description. It is not intended to be exhaustive or to limit the invention to the precise forms disclosed. Many variations and modifications of the embodiments described herein will be apparent to one of ordinary skill in the art in light of the above disclosure.

1. A method for separating at least one selected polymer from a mixture of polymers characterized by:
a) dissolution of the mixture of polymers in a first solvent, whereby the concentration of the mixture of polymers in the solution is being adjusted from 1 to 50 wt. %;
b) cooling the solution to a temperature T1, at which the selected polymer or the selected polymers at least partially is/are precipitated out in the form of a solid;
c) separating said solid from the solution;
d) washing the separated solid in a second solvent at a temperature T2 which is higher than temperature T1; and
e) separating the washed solid from the second solvent.

2. A method for separating at least one selected polymer from a mixture of polymers characterized by:
a) dissolution of the mixture of polymers in a first solvent, whereby the concentration of the mixture of polymers in the solution is being adjusted from 1 to 50 wt. %;
b) cooling the solution to a temperature T3, at which the selected polymer or the selected polymers at least partially is/are precipitated out in the form of a solid, and a suspension results;
c) heating of the suspension with or without the addition of the first solvent or a second solvent at a temperature T4, which is higher than temperature T3, whereby the suspension is preserved; and
d) separating the solid from the solution.

3. The method in accordance with claim 1 or claim 2, characterized by the fact that the polymers are of the polyolefin type.

4. The method in accordance with claim 3, characterized by the fact that the polyolefin plastics are of the LDPE (Low Density Polyethylene), LLDPE (Linear Low Density Polyethylene), MDPE (Medium Density Polyethylene), HDPE (High Density Polyethylene), UHDPE (Ultra High Density Polyethylene) and/or PP (Polypropylene) types.

5. The method in accordance with one of claims 1 to 4, characterized by the fact that the concentration of the mixture of polymers in the first solvent is 2 to 40 wt. %.

6. The method in accordance with one of claims 1 to 5, characterized by the fact that the concentration of the mixture of polymers in the first solvent is 5 to 20 wt. %.

7. The method in accordance with claim 1, characterized by the fact that the temperature T2 at which the solid is rewashed is approximately 5 to 40° C. above the precipitation temperature T1.

8. The method in accordance with claim 1, characterized by the fact that the temperature T2 at which the solid is rewashed is approximately 10 to 30° C. above the precipitation temperature T1.

9. The method in accordance with claim 2, characterized by the fact that the temperature T4 at which the solid is rewashed is approximately 5 to 40° C. above the precipitation temperature T3.

10. The method in accordance with claim 2, characterized by the fact that the temperature T4 at which the solid is rewashed is approximately 10 to 30° C. above the precipitation temperature T3.

11. The method in accordance with claim 1, characterized by the fact that the first solvent and the second solvent are chemically identical.

12. The method in accordance with claim 1, characterized by the fact that the second solvent is led back to step a).

13. The method in accordance with one of claims 1 to 12, characterized by the fact that the solvent used could be aliphatic, aromatic or cyclical, saturated or unsaturated hydrocarbons, alcohols, carboxylic acids, amines, esters, ketones, tetrahydrofurane, dimethylformamide, dimethylsulphoxide, N-Methylpyrrolidone or mixtures thereof.

14. The method in accordance with claims 1 to 12, characterized by the fact that the precipitation of the solid is supported by a precipitant.

15. A product produced with the method in accordance with one of claims 1 to 14, where the mixture of polymers consists of polyethylene and polypropylene characterized by the fact that it contains less than 20 to 30 wt. % LDPE or LLDPE.
